(19) United States
(12) Patent Application Publication
(10) Pub. No.: US 2026/0267579 A1
(43) Pub. Date: Sep. 10, 2026

(54) SYSTEM INCLUDING IMAGE FORMING APPARATUS AND SERVER APPARATUS

(71) Applicant: CANON KABUSHIKI KAISHA, Tokyo (JP)

(72) Inventors: SHUICHI TETSUNO, Kanagawa (JP); SHUNSUKE MATSUSHITA, Kanagawa (JP); MIKIHIKO HAMADA, Kanagawa (JP)

(21) Appl. No.: 19/554,406

(22) Filed: Mar. 2, 2026

(30) Foreign Application Priority Data
Mar. 10, 2025 (JP) 2025-037822

(51) Int. Cl. G06F 3/12; G03G 15/08; G03G 21/16

(52) U.S. Cl. CPC G06F 3/1238; G03G 15/0862; G03G 15/0863; G03G 21/1633; G03G 21/1676; G06F 3/1204; G06F 3/121; G06F 3/1235; G03G 2215/0697; G03G 2221/163; G03G 2221/1654; G03G 2221/1815; G03G 2221/1823

(57) ABSTRACT

A system includes an image forming apparatus, to which an accommodating device containing a consumable for image formation is detachably attached, and a server apparatus communicating with the image forming apparatus via a network. The image forming apparatus includes a replenishing path configured to replenish the consumable from the attached accommodating device, an opening and closing mechanism configured to open and close the replenishing path, a lock mechanism configured to lock actuation of the opening and closing mechanism, a consumable container configured to contain the replenished consumable, a detection unit configured to detect an amount of the consumable in the consumable container, and a notification unit configured to notify the server of the detected amount. The server apparatus is configured to issue an instruction to deliver the accommodating device according to the notified information and transmit, when delivery is made, an instruction to unlock the lock mechanism.

### BACKGROUND

### Field of the Technology

The present disclosure relates to a replenishment management system including an image forming apparatus and a server apparatus.

### Description of the Related Art

Image forming apparatuses, such as a copying machine, a printer, and a facsimile receiver, form images on recording media using consumables, such as toner and ink. When a consumable runs out, a user replaces the accommodating device that contains the consumable with a new accommodating device, and mounts the new accommodating device to the image forming apparatus to replenish the consumable to the consumable container of the image forming apparatus.

United States Patent Application Publication No. 2024-0094672 describes a replenishment management system in which a unique code provided on a replenishment pack as an accommodating device that contains a consumable is read using a user terminal. The replenishment management system described in United States Patent Application Publication No. 2024-0094672 performs authentication on the replenishment pack by the user terminal transmitting the above-described unique code to a server installed in a remote environment and then opens and closes the consumable replenishing port of the image forming apparatus. Use of the replenishment management system described in United States Patent Application Publication No. 2024-0094672 makes it possible for the user to replenish a consumable through the authentication of a replenishment pack.

The configuration described in United States Patent Application Publication No. 2024-0094672 causes the user to carry out an authentication task for a replenishment pack at the time of replenishing a consumable.

### SUMMARY

The present disclosure is directed to providing a system that allows appropriate replenishment of a consumable to a consumable container of an image forming apparatus even without a user's task, such as authentication.

According to an aspect of the present disclosure, a system including an image forming apparatus to which an accommodating device that contains a consumable to be used for image formation is detachably attached, and a server apparatus that communicates with the image forming apparatus via a network, the image forming apparatus includes a replenishing path configured to replenish the consumable from the attached accommodating device, an opening and closing mechanism configured to open and close the replenishing path, a lock mechanism configured to lock actuation of the opening and closing mechanism, a consumable container configured to contain the consumable replenished from the accommodating device, at least one memory that stores a set of instructions, at least one processor that executes the instructions causing the image forming apparatus to perform operations includes a detection unit configured to detect an amount of the consumable contained in the consumable container, and a notification unit configured to notify the server apparatus of information regarding the amount of the consumable detected by the detection unit, the server apparatus includes at least one memory that stores a set of instructions, at least one processor that executes the instructions causing the server apparatus to perform operations includes a delivery instruction unit configured to issue an instruction to deliver the accommodating device to be used by the image forming apparatus in accordance with the information regarding the amount of the consumable notified from the image forming apparatus, and a transmission unit configured to transmit to the image forming apparatus, in a case where the accommodating device is delivered to the image forming apparatus based on the delivery instruction issued by the delivery instruction unit, an instruction to unlock the lock mechanism.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are perspective views each illustrating an example of an external appearance of an image forming apparatus according to a first embodiment.

FIG. 2 is a cross-sectional view illustrating an example of an internal physical configuration of the image forming apparatus according to the first embodiment.

FIG. 3 is a perspective view illustrating an example of a configuration of a consumable replenishing path according to the first embodiment.

FIG. 4 is a cross-sectional view illustrating an example of a configuration of a storage unit and its surrounding area according to the first embodiment.

FIGS. 5A and 5B are perspective views each for describing an example of a schematic configuration of a replenishment pack according to the first embodiment.

FIGS. 6A and 6B are diagrams for describing opening and closing of a discharge tray according to the first embodiment.

FIG. 7 is a diagram illustrating a state in which the replenishment pack is connected to a toner receiver portion.

FIGS. 8A and 8B are diagrams for describing examples of a lock mechanism for locking an operation of an opening and closing mechanism.

FIG. 9 is a schematic diagram illustrating an example of a configuration of a replenishment management system according to the first embodiment.

FIG. 10 is a block diagram illustrating an example of a configuration of a management server according to the first embodiment.

FIG. 11 is a diagram for describing an example of an update of a database executed at the time of apparatus registration.

FIG. 12 is a diagram for describing an example of an update of the database executed at the time of pack delivery.

FIG. 13 is a block diagram illustrating an example of a functional configuration of the image forming apparatus according to the first embodiment.

FIG. 14 is a sequence diagram illustrating a procedure for a series of processes including provision of and replenishment with a replenishment pack according to the first embodiment.

FIG. 15 is a sequence diagram illustrating a procedure for a series of processes including provision of and replenishment with a replenishment pack according to a second embodiment.

FIG. 16 is a sequence diagram illustrating a procedure for a series of processes including provision of and replenishment with a replenishment pack according to a third embodiment.

### DESCRIPTION OF THE EMBODIMENTS

### First Embodiment

### 1. Description of Replenishment-type Image Forming Apparatus

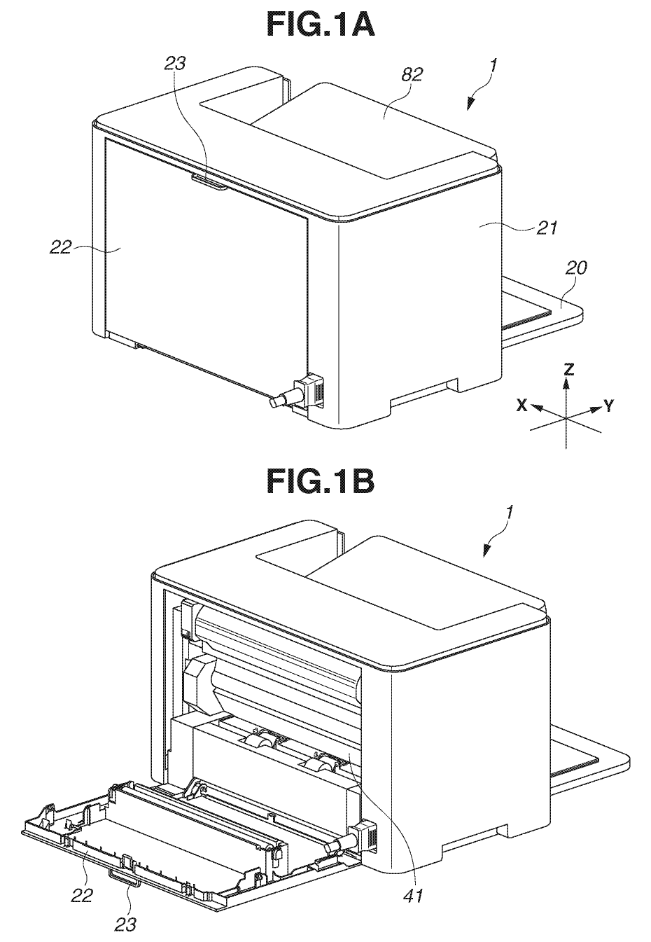

In this section, a basic configuration of a replenishment-type image forming apparatus will be described with reference to FIGS. 1A, 1B, 2, 3, 4, 5A, 5B, 6A, 6B, 7, 8A and 8B. In the following, an example will be described of a configuration of an image forming apparatus 1 as a monochrome laser printer.

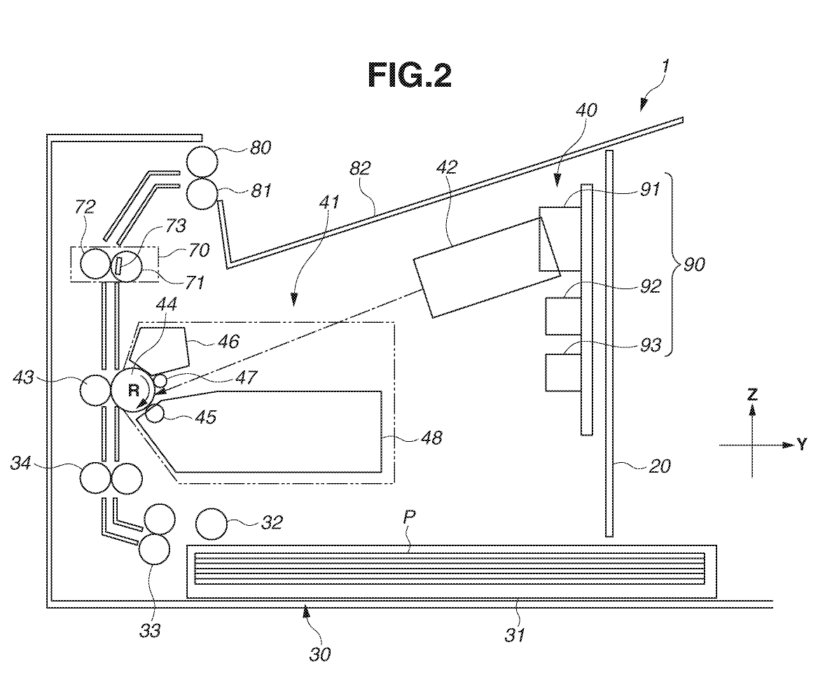

FIGS. 1A and 1B are perspective views illustrating an example of an external appearance of the image forming apparatus 1 according to a first embodiment. FIG. 2 is a cross-sectional view illustrating an example of an internal physical configuration of the image forming apparatus 1. The image forming apparatus 1 is a monochrome laser printer that forms an image on a recording medium based on input image data. Examples of the recording medium can include various media with different materials, such as paper, plastic film, an envelope, a sheet, and cloth.

In the following description, when the image forming apparatus 1 is installed on a horizontal surface, a height direction of the image forming apparatus 1 is defined as a Z direction. A direction that is orthogonal to the Z direction and parallel to a rotational axis direction (the main scanning direction) of a photosensitive drum 44 described below is defined as an X direction. A direction orthogonal to the X direction and the Z direction is defined as a Y direction.

### 1-1. External Appearance of Apparatus

A casing of the image forming apparatus 1 includes a front cover 20 (refer to FIG. 2), an external cover 21, a rear cover 22, and a discharge tray 82 (refer to FIG. 1A). The rear cover 22 is provided with a handle 23. The front cover 20 is disposed in a side surface of the image forming apparatus 1 in an openable and closeable manner to protect processing circuitry 90 described below. The rear cover 22 is disposed in the side surface of the image forming apparatus 1 opposed to the side surface in which the front cover 20 is disposed in an openable and closeable manner.

The user can grip the handle 23 of the rear cover 22 to open the rear cover 22 to expose a part of a conveyance path through which a recording medium is conveyed and a process unit 41, and then perform a maintenance task, such as clearing a jam or replacing the process unit 41. FIG. 1A illustrates a state in which the rear cover 22 is closed, and FIG. 1B illustrates a state in which the rear cover 22 is opened.

### 1-2. Internal Configuration of Apparatus

Referring to FIG. 2, the image forming apparatus 1 includes a sheet feeding unit 30, an image forming unit 40, a fixing unit 70, a pair of discharge rollers 80 and discharge port 81, and the processing circuitry 90. The sheet feeding unit 30 feeds recording media P to the image forming unit 40. The image forming unit 40 forms an image (a toner image) on a recording medium P while consuming toner as an example of a consumable. The fixing unit 70 fixes the image formed by the image forming unit 40 to the recording medium P. The pair of discharge rollers 80 discharges the recording medium P processed by the fixing unit 70 to the discharge tray 82.

The image forming unit 40 includes the process unit 41, a scanner unit 42, and a transfer roller 43. The process unit 41 includes the photosensitive drum 44, a development roller 45, a cleaning unit 46, a charging roller 47, and a storage unit 48. The process unit 41 may be fixed to the main body of the image forming apparatus 1, or may be removable.

The photosensitive drum 44, which is an image bearing member, includes a photosensitive layer formed by an organic photosensitive member on a drum-shaped base member. The photosensitive drum 44 is rotationally driven by a motor in an R direction illustrated in FIG. 2. A charging voltage is applied by a high-voltage power source to the charging roller 47, and the charging roller 47 in pressure contact with the photosensitive drum 44 uniformly charges the surface of the photosensitive drum 44. The scanner unit 42 emits a laser beam to the photosensitive drum 44 based on the input image data to expose the surface of the photosensitive drum 44 to the laser beam. By the exposure, an electrostatic latent image corresponding to the input image data is formed on the surface of the photosensitive drum 44. The scanner unit 42 may irradiate the photosensitive drum 44 with light from a light-emitting diode (LED) array instead of a laser beam.

The development roller 45 is rotatably supported by the storage unit 48. The storage unit 48 stores toner. The storage unit 48 may further include a supply roller, which is not illustrated in FIG. 2, for applying toner stored in the storage unit 48 to the surface of the development roller 45. A development voltage is applied by the high-voltage power source to the development roller 45. When toner borne on the development roller 45 comes into contact with the photosensitive drum 44, the toner is transferred from the development roller 45 to the surface of the photosensitive drum 44 based on the potential distribution on the surface of the photosensitive drum 44. As a result, the electrostatic latent image is developed into a toner image.

The sheet feeding unit 30 includes a cassette 31, a pickup roller 32, a pair of separation rollers 33, and a pair of conveyance rollers 34. The bundle of recording media P is loaded in the cassette 31. The cassette 31 can be drawn from the casing of the image forming apparatus 1. The pickup roller 32 picks up recording media P in the cassette 31 to feed the recording media P to the pair of separation rollers 33. The pair of separation rollers 33 separates the recording media P one by one to convey one recording medium P to the pair of conveyance rollers 34. The pair of conveyance rollers 34 conveys the recording medium P to a transfer nip between the transfer roller 43 and the photosensitive drum 44. A transfer voltage is applied by the high-voltage power source to the transfer roller 43, transferring the toner image produced by the development on the surface of the photosensitive drum 44 to the recording medium P conveyed to the transfer nip.

The recording medium P with the toner image transferred thereon is conveyed along the conveyance path to reach the fixing unit 70. The fixing unit 70 includes a heating roller 71, a pressing roller 72, and a fixing heater 73. The heating roller 71 and the pressing roller 72 heat and press the recording medium P while the recording medium P is passing through the nip between these rollers. As a result, toner particles are melted and then fixed, so that the toner image is fixed to the recording medium P. The recording medium P that has passed through the fixing unit 70 is discharged by the pair of discharge rollers 80 from a discharge port 81 to the discharge tray 82. The cleaning unit 46 is disposed near the photosensitive drum 44. The cleaning unit 46 cleans the photosensitive drum 44 by scraping off toner remaining on the surface of the photosensitive drum 44.

The processing circuitry 90 includes a group of electronic components 91, 92, and 93 disposed on a board. For example, the electronic component 91 may be a processor, the electronic component 92 may be a memory, and the electronic component 93 may be an input and output device. The input and output device may include a communication interface. In response to a job that instructs to form an image being input to the image forming apparatus 1, an image formation process starts based on input image data received from, for example, an external computer. In the image formation process, as described above, the scanner unit 42 forms an electrostatic latent image on the photosensitive drum 44 based on the input image data, the development roller 45 develops the electrostatic latent image into a toner image, and the toner image is transferred by the transfer roller 43 to the recording medium P. The processing circuitry 90 operates as a controller for controlling such an image formation process.

### 1-3. Detailed Configuration of Storage Unit

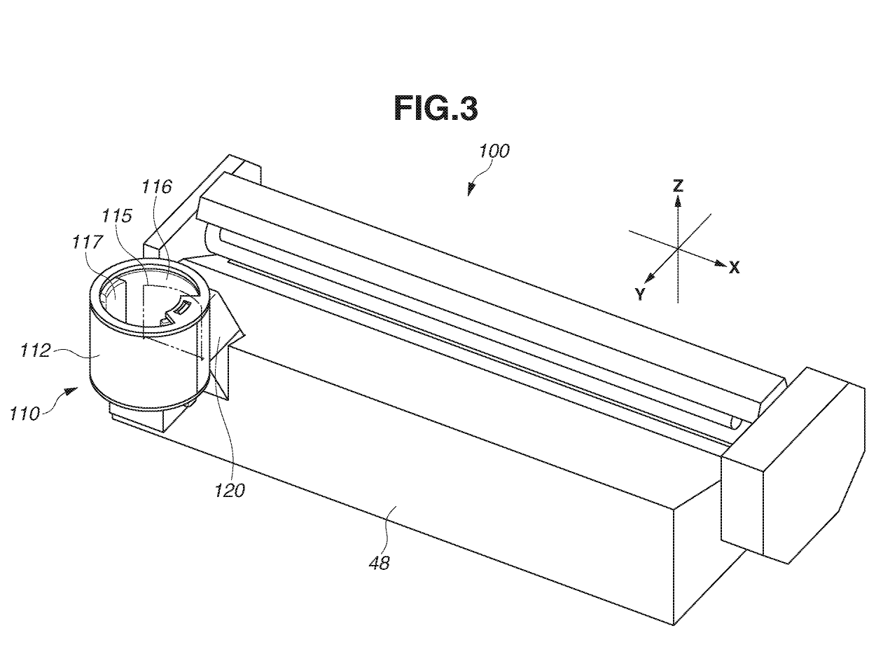

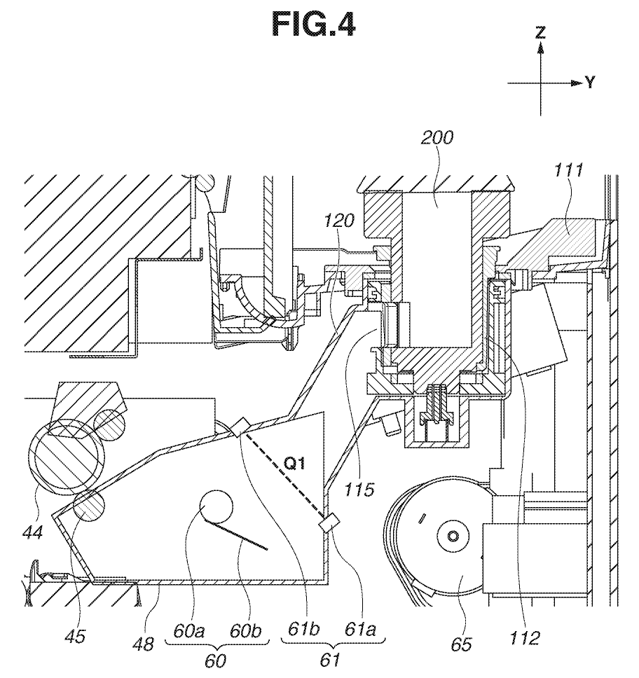

An example will be described of a specific configuration related to the storage unit 48 with reference to FIGS. 3 and 4. FIG. 3 is a perspective view for describing an example of a configuration of a consumable replenishing path in the image forming apparatus 1. FIG. 4 is a schematic cross-sectional view for describing an example of a configuration of the storage unit 48 and its surrounding area. Referring to FIG. 3, the storage unit 48 constitutes a part of a toner replenishing unit 100. The toner replenishing unit 100 includes the storage unit 48 and a toner receiver portion 110. The toner receiver portion 110 includes a cylindrical member 112, a main body shutter 116, and a connection member 120.

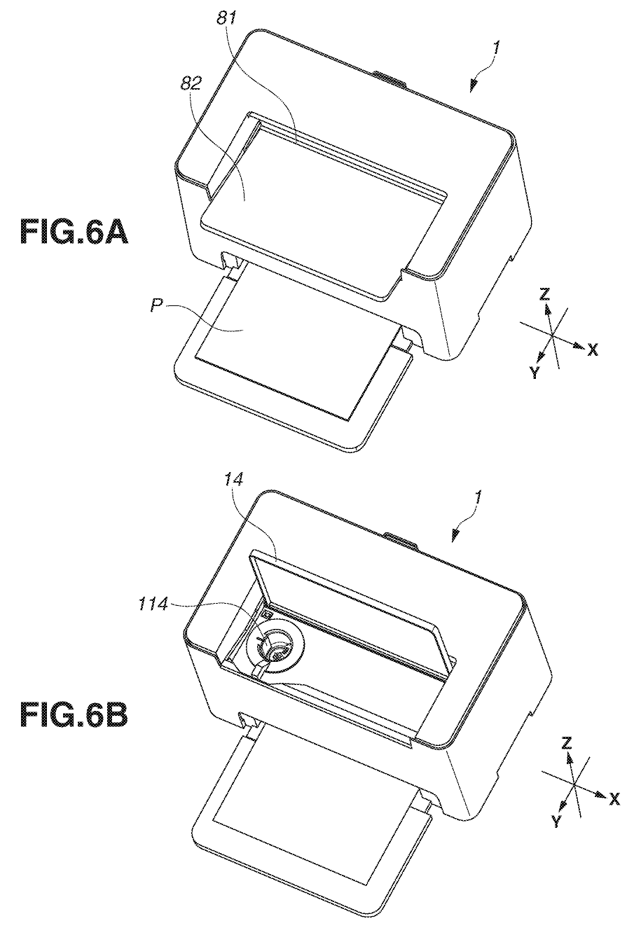

The toner receiver portion 110 also includes a ring member 111, which will be described in detail with reference to FIGS. 6A and 6B, 7, and 8A and 8B. However, in FIG. 3, the illustration of the ring member 111 is omitted for the purpose of illustrating other components. An internal space of the cylindrical member 112 communicates with the storage unit 48 via a side surface opening 115 and the hollow connection member 120. The main body shutter 116 serves as an opening and closing mechanism that can open and close the replenishing path for a consumable (in this case, toner) to the storage unit 48 from a replenishment pack 200 described below.

A protruding portion 117 is formed on the inner surface of the main body shutter 116.

FIG. 4 illustrates a state in which the replenishment pack 200 is attached to the toner receiver portion 110, together with a cross-section of a configuration of the storage unit 48 and its surrounding area. The replenishment pack 200 is an example of an accommodating device that contains a consumable to be consumed during image formation. The replenishment pack 200 is detachable from and attachable to the image forming apparatus 1. When the main body shutter 116 is opened, the replenishing path extending from the attached replenishment pack 200 to the storage unit 48 through the connection member 120 is opened. In a state in which the replenishing path is opened, toner discharged from the replenishment pack 200 is replenished to the storage unit 48 through the replenishing path.

As illustrated in FIG. 4, an agitation member 60 is disposed in the storage unit 48. The agitation member 60 includes a shaft 60a arranged in the X direction, and a blade 60b that turns about the shaft 60a. The blade 60b is driven by a motor 65 to rotate. By rotation of the blade 60b, toner in the storage unit 48 is agitated and reaches the development roller 45. The agitation member 60 may include a spiral member instead of the blade 60b. The agitation member 60 may serve to uniformize toner in the storage unit 48 by removing toner from the development roller 45 and circulating toner in the storage unit 48.

A remaining amount detection unit 61 is also disposed in the storage unit 48. The remaining amount detection unit 61 is a sensor for detecting the remaining amount of toner in the storage unit 48, and is an example of a detection unit that detects the amount of a consumable. The remaining amount detection unit 61 includes a light emitter 61a and a light receiver 61b. The light emitter 61a emits light that travels inside the storage unit 48 along an optical axis Q1. The light receiver 61b is disposed at a position where the light receiver 61b faces the light emitter 61a to receive light emitted from the light emitter 61a. In a case where light is guided by a light guiding tube, for example, the light receiver 61b is not necessarily disposed at a position where the light receiver 61b faces the light emitter 61a. The light emitter 61a may be a light-emitting element, such as an LED, or may be a halogen lamp, or a fluorescent lamp. The light receiver 61b may be, for example, a phototransistor, a photodiode, or an avalanche photodiode.

The light receiver 61b outputs a light detection signal having a signal level depending on the amount of light received.

The light detection signal is analog-to-digital converted, for example, and then input to the processing circuitry 90. The processing circuitry 90 may estimate the remaining amount of toner, for example, based on the ratio of the time during which light from the light emitter 61a is shielded (by toner) with respect to a fixed time window while the toner is being agitated. The configuration of the remaining amount detection unit 61 is not limited to the example described above, and the remaining amount of toner may be detected or estimated by any method. For example, the remaining amount of toner may be estimated by subtracting a cumulative amount of toner consumed after the last toner replenishment from a total amount at the last toner replenishment. The processing circuitry 90 may derive an amount of toner consumed based on a statistical value related to an image formation operation, such as the number of recording media used by printing or a pixel count.

### 1-4. Configuration of Replenishment Pack

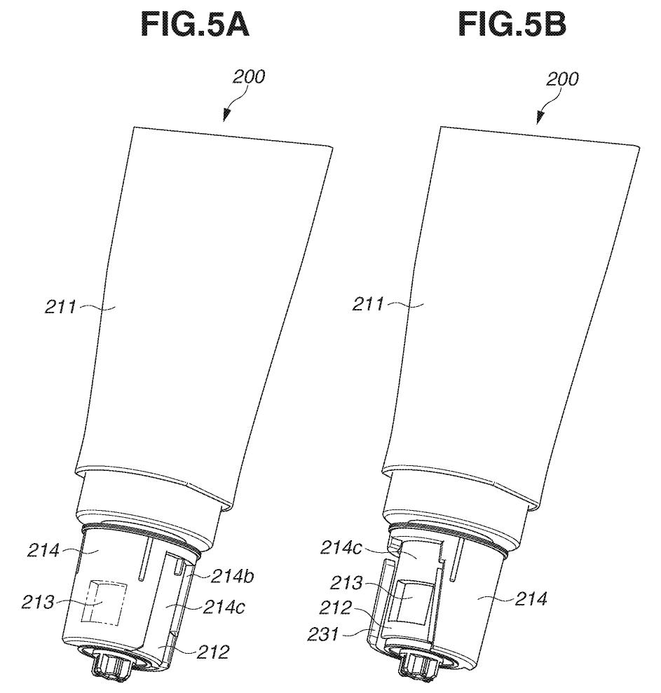

FIGS. 5A and 5B each illustrate an example of a schematic configuration of the replenishment pack 200. In this configuration example, the replenishment pack 200 includes an accommodating unit 211, a nozzle 212, and a pack shutter 214.

The accommodating unit 211 can be formed, for example, as a hollow tube or pouch, to contain toner, which is a consumable. The accommodating unit 211 is preliminarily filled with toner. The accommodating unit 211 may be, for example, an easily deformable plastic bag member. However, the accommodating unit 211 is not limited to this example. The accommodating unit 211 may be made of a desired material, such as resin, paper, or vinyl, and may have a desired shape, such as a bottle, a cylinder, or a box.

The nozzle 212 is an interface portion with the toner receiver portion 110 of the image forming apparatus 1. The inside of the nozzle 212 communicates with the inside of the accommodating unit 211. In the side surface of the nozzle 212, an opening 213 for discharging toner to the outside is formed. The opening 213 is ordinarily closed by the pack shutter 214.

The pack shutter 214 is a cylindrical member concentric with the nozzle 212, and is disposed radially outward of the nozzle 212. The pack shutter 214 has an opening 214c therein. A part of a rim portion forming the opening 214c constitutes a drive transmission surface 214b. At the time of toner replenishment, the pack shutter 214 is rotated relative to the nozzle 212 so that the opening 213 in the nozzle 212 overlaps the opening 214c in the pack shutter 214, opening a toner discharge path closed by the pack shutter 214. As described below, the drive transmission surface 214b receives force to rotate the pack shutter 214. FIG. 5A illustrates a state in which the toner discharge path is blocked, and FIG. 5B illustrates a state in which the toner discharge path is opened. On the inner circumferential surface of the pack shutter 214, a sealing member 231 that ordinarily shields the opening 213 in the nozzle 212 can be further disposed. The sealing member 231 prevents leakage of toner from the replenishment pack 200 when toner is not being replenished.

### 1-5. Replenishment of Consumable

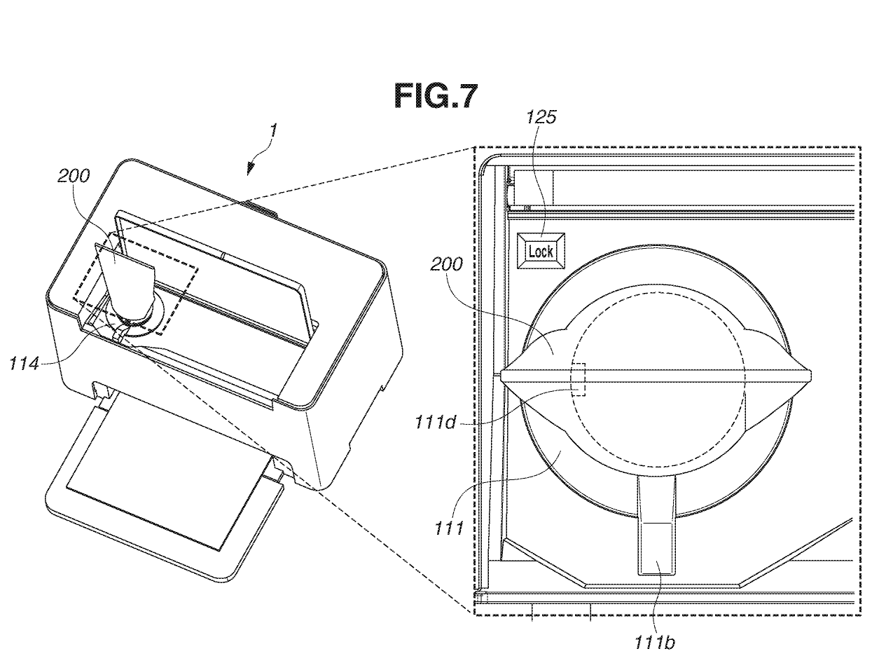

A connection of the replenishment pack 200 to the toner receiver portion 110 will now be described with reference to FIGS. 6A and 6B and 7. As illustrated in FIGS. 6A and 6B, the discharge tray 82 is configured to be openable and closeable around an opening and closing shaft arranged in the casing in the X direction. In the example illustrated in FIG. 6A, the discharge tray 82 is in a closed state, and the recording medium P discharged from the discharge port 81 is discharged onto the discharge tray 82 in that state. In the example illustrated in FIG. 6B, the discharge tray 82 is in an opened state, and a replenishing port 114 in the toner receiver portion 110 is exposed in that state. Thus, in this configuration example, the discharge tray 82 also serves as a shielding member that shields the replenishing port 114. The user can lift and open the discharge tray 82 as illustrated in FIG. 6B to connect the replenishment pack 200 to the toner receiver portion 110 by inserting the nozzle 212 of the replenishment pack 200 into the exposed replenishing port 114 as illustrated on the left of FIG. 7.

The right of FIG. 7 illustrates a state in which the replenishment pack 200 is connected to the toner receiver portion 110 in an enlarged manner. The ring member 111 surrounding the replenishing port 114 is rotatably supported on the top surface of the cylindrical member 112. The ring member 111 includes a lever 111b configured to be gripped by the user, and a protruding portion 111d indicated by dotted lines in FIG. 7. The protruding portion 111d engages with the drive transmission surface 214b of the pack shutter 214 of the replenishment pack 200 inserted into the toner receiver portion 110. The drive transmission surface 214b also engages with the protruding portion 117 (refer to FIG. 3) of the main body shutter 116. When the user rotates the ring member 111 around the central axis by operating the lever 111b, force generated in the rotational direction is transmitted from the protruding portion 111d to the drive transmission surface 214b of the pack shutter 214, and further transmitted from the drive transmission surface 214b to the protruding portion 117 of the main body shutter 116. This transmitted force causes the main body shutter 116 and the pack shutter 214 of the replenishment pack 200 to be rotated in conjunction with the ring member 111, and the toner replenishing path is opened, for example, after a 90-degree rotation. When the replenishing path is opened, toner stored in the accommodating unit 211 of the replenishment pack 200 flows out of the opening 213 of the nozzle 212 into the toner receiver portion 110, and is replenished through the connection member 120 to the storage unit 48. The rotation of the ring member 111 is restricted by a not-illustrated regulation member so as not to rotate beyond a predetermined maximum rotational angle.

In the above-described example, the example has been described in which the toner replenishing path is opened by force in the rotational direction generated by the user operating the lever 111b, but closing and opening of the replenishing path may be performed without relying on the user’s operation. As an example, the image forming apparatus 1 may include a pack sensor that detects a state in which the replenishment pack 200 is connected to the toner receiver portion 110, and a drive motor that generates drive force to rotate the ring member 111. In this example, the processing circuitry 90 may actuate the drive motor under the condition that the connection of the replenishment pack 200 to the toner receiver portion 110 has been detected by the pack sensor to rotate the ring member 111 by rotational force of the drive motor to open the replenishing path.

The opening and closing mechanism for opening and closing the replenishing path is not limited to the above-described mechanism with the rotating shutter. A shutter movable in a linear direction may be employed instead of a rotating shutter, or a mechanism different from using a shutter, such as using a valve, may be employed. Further, the opening and closing mechanism may be provided in at least one of an accommodating device, such as the replenishment pack 200, and the image forming apparatus 1. Thus, the replenishing path from the accommodating device to the image forming apparatus may be constantly opened on one side of the accommodating device and the image forming apparatus, and be opened and closed only on the other side. Alternatively, the replenishing path may be opened and closed on both sides of the accommodating device and the image forming apparatus as in the above-described example. Further, a sensor used to detect the user’s operation of the opening and closing mechanism, or detect a state of the opening and closing mechanism (the opened state or the closed state) may be additionally disposed.

The actuation of the above-described opening and closing mechanism may be prevented (through the user operation or automatically) by a lock mechanism described in the following. Similarly to the opening and closing mechanism, the lock mechanism may be disposed at least either in the accommodating device or the image forming apparatus. A leakage prevention member, such as a lid or a cap, for preventing toner leakage may be attached to the replenishing port 114 in the image forming apparatus 1 or to the opening 213 in the replenishment pack 200. Such a leakage prevention member may be removable by the user at a desired time.

### 1-6. Lock and Unlock of Opening and Closing Mechanism

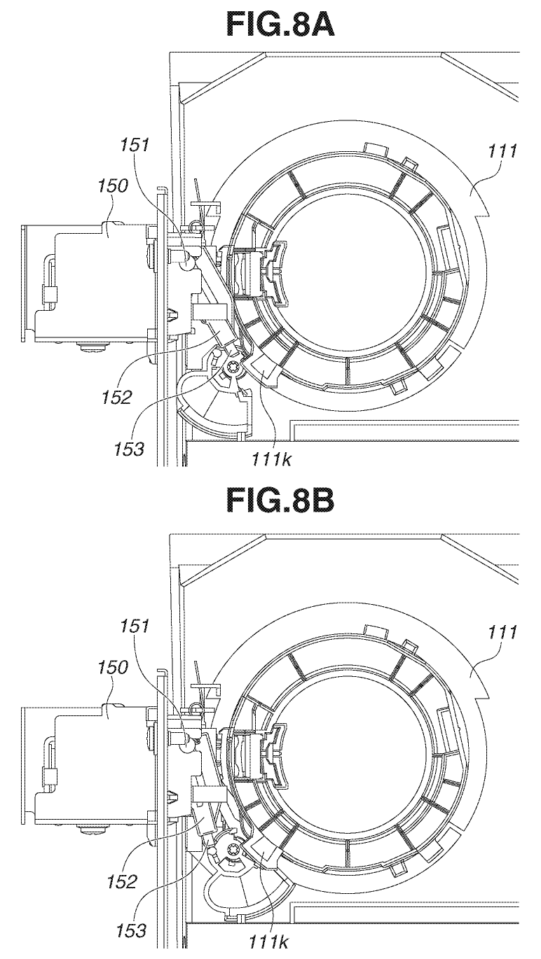

The ring member 111 of the image forming apparatus 1 is ordinarily locked so as not to be rotated even when force is applied by the user. FIGS. 8A and 8B are each a diagram for describing an example of the lock mechanism for locking the rotation of the ring member 111. FIGS. 8A and 8B each illustrate the toner receiver portion 110 viewed from inside the apparatus (in the Z direction) so that an example of an internal configuration of the toner receiver portion 110 can be understood in more detail. The toner receiver portion 110 includes a lock unit 150, for example. The lock unit 150 includes a rod-shaped lock member 152 having one end supported by a shaft 151, and being pivotable around the shaft 151. The ring member 111 also includes a protrusion 111k. The lock member 152 is ordinarily urged by elastic force of a spring (not illustrated) in the lock unit 150 in a direction in which an end 153 opposite to the shaft 151 is away from the lock unit 150, so that the end 153 is positioned on the rotational trajectory of the protrusion 111k of the ring member 111. Thus, even when the user rotates the ring member 111 clockwise in FIGS. 8A and 8B (in the Rc direction in FIGS. 8A and 8B), the end 153 of the lock member 152 interferes with the protrusion 111k, preventing the rotation of the ring member 111. In other words, the opening and closing mechanism for the replenishing path is locked in the closed state (refer to FIG. 8A).

The lock unit 150 further includes a solenoid (not illustrated) configured to pivot the lock member 152 in a direction opposite to the elastic force of the spring. The solenoid is temporarily energized during a period in which toner replenishment from the replenishment pack 200 to the image forming apparatus 1 is allowed, and pivots the lock member 152 using its attractive force. When the solenoid is energized and the lock member 152 pivots, the end 153 of the lock member 152 retracts from the rotational trajectory of the protrusion 111k of the ring member 111 (refer to FIG. 8B), which allows the user to rotate the ring member 111 clockwise in FIGS. 8A and 8B. Thus, the opening and closing mechanism for the replenishing path is unlocked (released from a locked state). The opening and closing mechanism for the replenishing path being unlocked (released from the locked state) means that opening of the replenishing path is allowed, enabling a replenishing operation using the replenishment pack 200. Such locking and unlocking of the opening and closing mechanism are controlled by the processing circuitry 90. Various examples of conditions for unlocking the opening and closing mechanism will be described below. Further, the configuration of the lock mechanism that locks and unlocks the opening and closing mechanism is not limited to the above-described example, and may be a desired mechanical, electromagnetic, electrical, or software mechanism. For example, the lock member 152 may be driven by a motor or another type of actuator instead of a solenoid. In a case where an opening and closing mechanism actuated by computer control without relying on a user’s operation is employed, locking and unlocking of the opening and closing mechanism may be implemented simply by program code.

As illustrated on the right of FIG. 7, an indicator 125 is disposed near the ring member 111. The indicator 125 indicates to the user whether the above-described opening and closing mechanism is in a locked state or in an unlocked state. The indicator 125 includes, for example, an LED disposed in the casing, and a window for transmitting light from the LED. In a case where the indicator 125 indicates that the opening and closing mechanism is in the unlocked state, the user can rotate the ring member 111 to open the replenishing path.

### 2. Replenishment management system

### 2-1. Overview of System

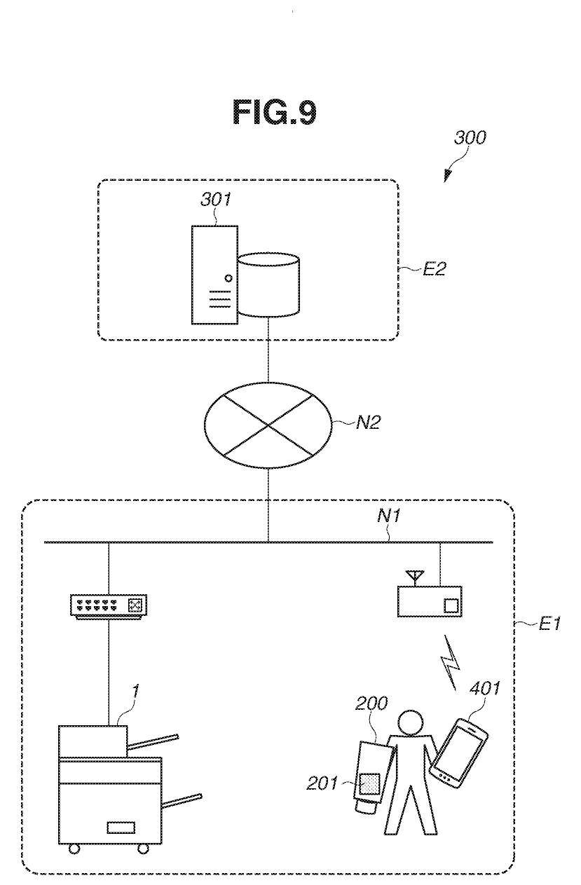

FIG. 9 is a schematic diagram illustrating an example of a configuration of a replenishment management system 300 according to the first embodiment. Referring to FIG. 9, the replenishment management system 300 includes the image forming apparatus 1, a management server 301, and a user terminal 401.

The image forming apparatus 1 is installed in a user environment E1 where the user exists. The user terminal 401 also exists in the user environment E1, and is held by the user. The image forming apparatus 1 and the user terminal 401 are connected to a local network N1, which can be a local area network (LAN), for example. The management server 301 is installed in a remote environment E2. The remote environment E2 is connected to the local network N1 via an external network N2.

The external network N2 may be the Internet or a virtual private network (VPN), for example. The local network N1 and the external network N2 may each include any number of network devices of desired types, such as a router, a switch, a gateway, a wireless access point, and a base station.

In the user environment E1, the user uses the image forming apparatus 1. As described above, the image forming apparatus 1 forms an image on a recording medium while consuming toner as a consumable. When toner stored in the image forming apparatus 1 runs out, the user connects the replenishment pack 200 as an accommodating device that stores toner to the image forming apparatus 1, and replenishes toner from the replenishment pack 200 to the image forming apparatus 1. If the replenishment pack 200 becomes empty without a spare replenishment pack 200 in the user environment E1, when toner runs out next time, the image forming apparatus 1 becomes unavailable. In the present embodiment, to prevent such a situation, the management server 301 remotely manages usage statuses of the image forming apparatus 1 and the replenishment pack 200 used by each user.

The management server 301 is a server apparatus for managing toner replenishment from the replenishment pack 200 to the image forming apparatus 1. The management server 301 centrally manages usage statuses of each image forming apparatus 1 used by a plurality of users. The management server 301 may be implemented, for example, as an application server, a database server, or a cloud server using a high-performance general-purpose computer. The user terminal 401 is a terminal device that provides the user with a user interface for supporting the replenishment management function of the management server 301. The user terminal 401 may be a general-purpose terminal device, such as a smartphone or another type of a mobile phone, a personal computer (PC), or a personal digital assistant (PDA). The image forming apparatus 1 may also provide the user with a user interface.

Functions of the management server 301, which will be described in detail below, may be provided by a single device or by a plurality of physically-separated devices by cooperating with each other. Further, a part of databases described as being stored in the management server 301 may instead be stored in a device other than the management server 301 (for example, another database server).

### 2-2. Configuration Example of Management Server

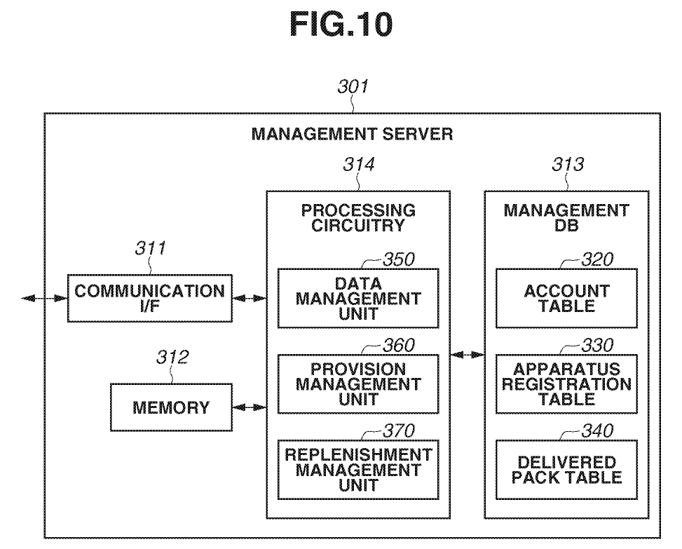

FIG. 10 is a block diagram illustrating an example of a configuration of the management server 301 according to the present embodiment.

Referring to FIG. 10, the management server 301 includes a communication interface (I/F) 311, a memory 312, a management database (DB) 313, and processing circuitry 314.

The communication I/F 311 is used for the management server 301 to communicate with another device. For example, the communication I/F 311 communicates with the image forming apparatus 1 and the user terminal 401 that exist in the user environment E1. The communication I/F 311 may be a wired communication interface or a wireless communication interface.

The memory 312 may include a storage medium of a desired type, for example, a semiconductor memory, such as a read only memory (ROM) or a random access memory (RAM), an optical disk, or a magnetic disk. Examples of the memory 312 may include a non-transitory computer-readable storage medium. The memory 312 stores one or more computer programs to be executed by the processing circuitry 314, and various types of data.

The management DB 313 includes a group of tables for managing the replenishment of consumables to one or more image forming apparatuses under the management of the replenishment management system 300. Specifically, as illustrated in FIG. 10, the management DB 313 includes an account table 320, an apparatus registration table 330, and a delivered pack table 340.

The account table 320 holds information regarding the accounts of users who use the replenishment pack 200 provided by the replenishment management system 300. The account table 320 can include, for example, one or more of the following information items:

"user ID"

"password"

"name"

"e-mail address"

"address"

"contract type"

"payment method"

The "user ID" is identification information for uniquely identifying each user account. The "password" is used in user authentication executed when the user logs into the system. The "name" refers to the user name of each account. The user name is displayed, for example, on a screen after login, and can be used as a recipient name for delivery of the replenishment pack 200. The "address" can be used as a delivery address in the delivery of the replenishment pack 200. The "e-mail address" can be used when the system issues various notifications to each user by e-mail. The "contract type" refers to the type of a contract concluded by each user with a business operator who operates the replenishment management system 300. A provision management unit 360 described below can determine when the replenishment pack 200 is to be delivered to each user depending on the contract type of the user. The "payment method" relates to a method by which payment for the replenishment pack 200 provided to each user is settled.

The apparatus registration table 330 holds information regarding image forming apparatuses registered in the replenishment management system 300 as apparatuses of respective users. The apparatus registration table 330 includes, for example, one or more of the following information items:

"owner"

"apparatus ID"

"registration date"

"status"

"remaining amount of toner"

The "owner" refers to the account of a user who owns or manages each image forming apparatus using a "user ID" registered in the account table 320. The "apparatus ID" is identification information used to uniquely identify each image forming apparatus. The pair of the "owner" and the "apparatus ID" indicates an association between each user account and at least one image forming apparatus registered as an apparatus of a user having the corresponding account. Two or more image forming apparatuses may be associated with a single user account. The "registration date" refers to a date on which the "apparatus ID" of each image forming apparatus was registered in the apparatus registration table 330. The "status" refers to a status related to verification as to whether each image forming apparatus is actually installed in a user environment of the "owner". At the time of initial registration of the "apparatus ID", the "status" shows "unverified", and in response to completion of verification, the "status" can be changed to "verified". The "remaining amount of toner" refers to a value of the latest remaining amount of toner detected and reported by each image forming apparatus. For example, the "remaining amount of toner" is represented as a percentage.

The delivered pack table 340 holds information regarding replenishment packs dispatched to each user. The delivered pack table 340 includes, for example, one or more of the following information items:

"contractant"

"pack ID"

"dispatch date"

"status"

"usage date"

The "contractant" is indicated by "user ID" registered in the account table 320 represented as an account of a user who is the recipient of the replenishment pack. The "pack ID" is identification information for uniquely identifying each replenishment pack. The pair of the "contractant" and the "pack ID" indicates an association between each user account and at least one replenishment pack provided to the user having the corresponding account. Each user repeatedly consumes toner, and thus the number of replenishment packs associated with a single user account in the delivered pack table 340 increases as time elapses. The "dispatch date" refers to a date on which a replenishment pack is dispatched to the "contractant". The "status" refers to whether each replenishment pack was used to replenish toner in an image forming apparatus. At the time of dispatch, the "status" shows "unused", and after each replenishment pack arrives at the user environment, authentication is completed, and toner replenishment is performed, which can change the "status" to "used". The "usage date" refers to a date on which the replenishment pack was used to replenish toner.

The processing circuitry 314, which may be, for example, a central processing unit (CPU), provides various functions of the management server 301 by executing computer programs stored in the memory 312. Specifically, as illustrated in FIG. 10, the processing circuitry 314 functions as a data management unit 350, the provision management unit 360, and a replenishment management unit 370.

The data management unit 350 manages the registration and the update of data in the management DB 313. The data management unit 350 causes the user terminal 401 to display a screen for receiving an entry of account information to be registered in the account table 320, receives the entered account information via the communication I/F 311, and registers the entered account information in the account table 320. Similarly, the data management unit 350 displays on the user terminal 401 a screen for receiving an entry of apparatus information regarding an image forming apparatus owned by each user, receives the entered apparatus information via the communication I/F 311, and registers the entered apparatus information in the apparatus registration table 330. These entry screens may be provided in any form, such as a web page, an entry form, or an application screen. Typically, receiving an entry of apparatus information is performed while the user is logged in to the system after successful user authentication using a user ID and a password.

Specifically, in the present embodiment, the data management unit 350 performs simple verification as to whether an apparatus in apparatus information registered in the apparatus registration table 330 is actually installed in a user environment of the corresponding user. For example, in a case where the user logs in to the system and enters apparatus information about the image forming apparatus 1 on the entry screen, the data management unit 350 presents a message prompting the user to perform a predetermined operation on the image forming apparatus 1. Examples of the predetermined operation may include pressing a specific physical button of the image forming apparatus 1 and touching a button on a graphical user interface (GUI). Further, in preparation for a case where the image forming apparatus 1 is turned off, the message also notifies the user to turn on the power of the image forming apparatus 1. When the user performs the prompted operation on the image forming apparatus 1, the image forming apparatus 1 transmits an apparatus ID for identifying the image forming apparatus 1 to the management server 301. The data management unit 350 waits to receive the apparatus ID from the image forming apparatus 1 until a predetermined period elapses from the presentation of the above-described message. Then, in a case where the same apparatus ID as the apparatus ID entered by the user is received from the image forming apparatus 1 before a timeout, the data management unit 350 determines that the image forming apparatus 1 identified by the apparatus ID is actually installed in the user environment. The data management unit 350 sets a value of the "status" in the apparatus registration table 330 to "unverified" for an apparatus for which the verification has not been completed, and sets a value of the "status" in the apparatus registration table 330 to "verified" for an apparatus for which the verification has been completed.

In the present embodiment, the data management unit 350 also manages the update of the value of the "remaining amount of toner" in the apparatus registration table 330. For example, the data management unit 350 receives remaining amount information regarding the remaining amount of a consumable in the storage unit 48 of the image forming apparatus 1 via the communication I/F 311 from the registered image forming apparatus 1. The data management unit 350 then updates the status information regarding the remaining amount of the consumable (i.e., a value of the "remaining amount of toner" in the apparatus registration table 330) based on the received remaining amount information.

The provision management unit 360 manages provision of the replenishment pack 200 to the user of the replenishment management system 300. For example, the provision management unit 360 monitors occurrence of a trigger event that triggers provision of the replenishment pack 200 to the user.

An example of the trigger event is purchase of the replenishment pack 200 by the user. For example, when an order for the replenishment pack 200 is received on a website for selling consumables for image forming (i.e., when an individual contract is concluded), the provision management unit 360 starts provision of the replenishment pack 200 to the user as the purchaser.

Another example of the trigger event is arrival of a provision timing based on a contract with the user. For example, it is assumed that a certain user has concluded a regular purchase contract of regularly purchasing a certain number of replenishment packs 200 (for example, once a month or once every several months) with the business operator. In a case where it is determined that the next provision timing for the replenishment pack 200 has arrived for such a user, the provision management unit 360 starts provision of the replenishment pack 200 to the user.

Another yet example of the trigger event may be detection of a decrease in the remaining amount of toner in the image forming apparatus 1 registered in the apparatus registration table 330. For example, it is assumed that a certain user has concluded with the business operator an automatic purchase contract of automatically receiving provision of a new replenishment pack 200 when the remaining amount of toner in the image forming apparatus 1 owned by the certain user decreases. In this case, the provision management unit 360 may monitor, for the user’s registered image forming apparatus 1, the value of the "remaining amount of toner" in the apparatus registration table 330, and when it is determined that the remaining amount of toner falls below a predetermined threshold value, the provision management unit 360 may start provision of the replenishment pack 200 to the user. Additionally or alternatively, a trigger event related to automatic purchase of the replenishment pack 200 may be the number of operation times of the registered image forming apparatus 1 (for example, the number of times jobs are executed, or the cumulative total number of recording media consumed) reaching a threshold value. Additionally or alternatively, a trigger event related to automatic purchase of the replenishment pack 200 may be detection of the usage of the replenishment pack 200 provided to the user in the past. For example, the provision management unit 360 monitors the "status" in the delivered pack table 340 for the replenishment pack 200 provided to the user who has concluded the automatic purchase contract, and when the value of the "status" changes from "unused" to "used", the provision management unit 360 starts provision of the replenishment pack 200.

By providing a new replenishment pack 200 to the user regularly or automatically in response to detection of these trigger events, it is possible to reduce the likelihood that a consumable runs out at an unexpected timing for the user and the image forming apparatus 1 becomes unavailable.

The provision management unit 360 can determine which of the above-described trigger events is to be monitored based on the "contract type" of each user in the account table 320. When it is determined that a trigger event has occurred for a certain user, the provision management unit 360 allocates a new replenishment pack 200 to the user, and then transmits a message that issues an instruction to deliver the allocated replenishment pack 200 to a delivery person. Further, the provision management unit 360 adds a new record indicating a user ID of a delivery destination user and a pack ID identifying the allocated replenishment pack 200 to the delivered pack table 340 to register an association between the user account and the replenishment pack 200 in the management DB 313. The "dispatch date" in the delivered pack table 340 can be set to a date on which the replenishment pack 200 is to be dispatched, and the "status" and the "usage date" can be set to "unused" and blank, respectively, as initial values.

As described above, at least either the replenishment pack 200 or the image forming apparatus 1 includes the opening and closing mechanism that can open and close a replenishing path for a consumable. The opening and closing mechanism is ordinarily locked by the lock mechanism so that the replenishing path is not opened. Upon receiving a result indicating that the replenishment pack 200 has been dispatched to the user, the replenishment management unit 370 issues an unlock command to the image forming apparatus 1 via the communication I/F 311 to allow the image forming apparatus 1 to open the replenishing path using the opening and closing mechanism. In the image forming apparatus 1, in a case where the opening and closing mechanism is actuated by computer control without relying on the user’s operation, the replenishment management unit 370 may cause the opening and closing mechanism of the image forming apparatus 1 to open the replenishing path for a consumable instead of unlocking the opening and closing mechanism. An unlock command (or an open command) to the image forming apparatus 1 may be directly issued from the management server 301 to the image forming apparatus 1.

When the opening and closing mechanism is unlocked based on an authentication result, the replenishing path is opened and toner is replenished from the replenishment pack 200 to the image forming apparatus 1, the remaining amount of toner in the storage unit 48 of the image forming apparatus 1 increases. As described below, the image forming apparatus 1 detects the remaining amount of toner in the storage unit 48, and transmits remaining amount information to the management server 301. The data management unit 350 receives the remaining amount information via the communication I/F 311, and updates the value of the "remaining amount of toner" in the apparatus registration table 330. Further, in a case where the received remaining amount information indicates an increase in the remaining amount of toner, the data management unit 350 changes the "status" of the replenishment pack 200 in the delivered pack table 340 to "used". With this configuration, in a case where the user attempts to reuse the same replenishment pack 200 thereafter, the replenishment management unit 370 can prevent the replenishment pack 200 from being reused based on the status information. Further, the provision management unit 360 can also allocate a new replenishment pack 200 to the user in response to detecting use of the replenishment pack 200.

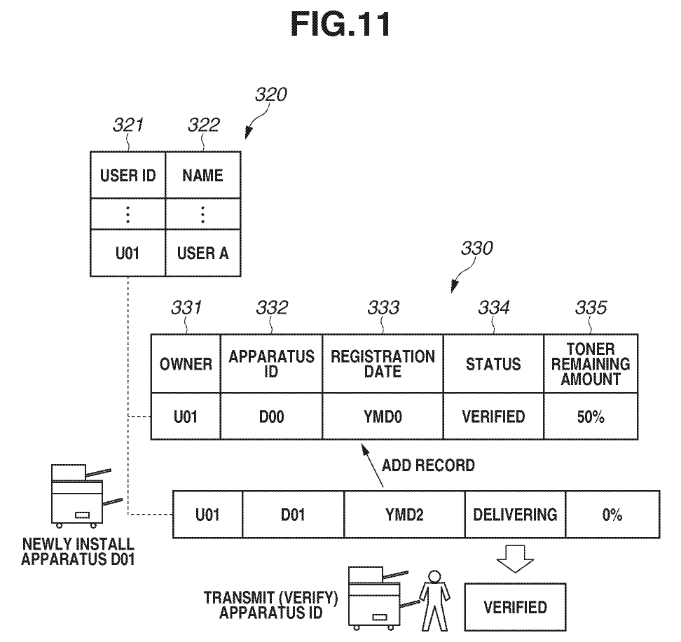

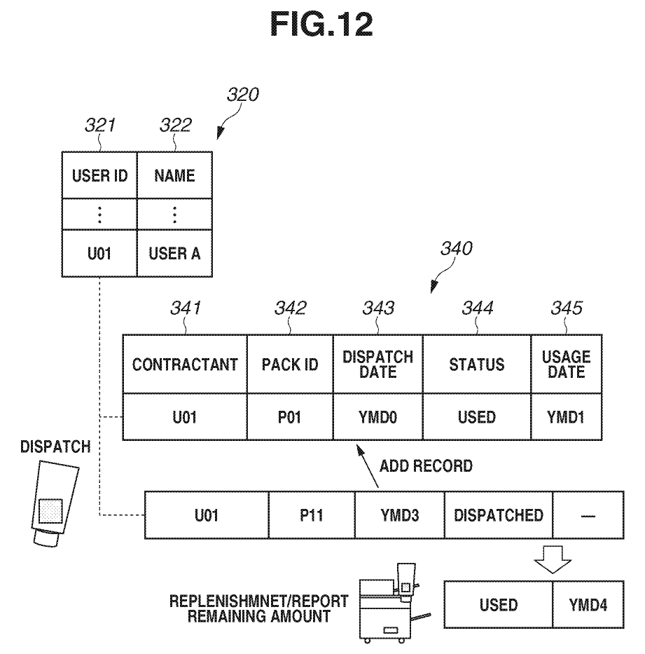

Update of the content of the management DB 313 according to a procedure of typical processing will now be described with reference to FIGS. 11 and 12. FIG. 11 illustrates an example of an update of the apparatus registration table 330 performed during apparatus registration. In the upper part of FIG. 11, an account table 320 including a user ID 321 and a name 322 as data items is illustrated. The illustration of other data items in the account table 320 is omitted in FIG. 11. In the middle part of FIG. 11, an apparatus registration table 330 including, as data items, an owner 331, an apparatus ID 332, a registration date 333, a status 334, and a remaining amount of toner 335 is illustrated. In the example illustrated in FIG. 11, an account of a user identified by a user ID "U01" (hereinafter, will be referred to as a user U01) has already been registered in the account table 320. Further, an image forming apparatus identified by an apparatus ID "D00" is registered in the apparatus registration table 330 as an apparatus of the user U01.

The user U01 newly installs an image forming apparatus identified by an apparatus ID "D01" (hereinafter, will be referred to as an apparatus D01) in the user environment E1. When the user U01 enters apparatus information about the apparatus D01 via an entry screen provided by the management server 301, a record for the apparatus information about the apparatus D01 is added to the apparatus registration table 330 by the management server 301. In the added record, the owner 331 shows "U01", the apparatus ID 332 shows "D01", the registration date 333 shows a date on which the registration was performed, the status 334 shows "unverified", and the remaining amount of toner 335 shows "0%".

Further, for example, the user U01 performs an operation for apparatus registration on the newly installed apparatus D01 based on a message displayed on a screen. The apparatus D01 stores in advance its apparatus ID "D01", and transmits apparatus information including the apparatus ID to the management server 301 based on an operation performed by the user. When the apparatus ID received in this manner matches the apparatus ID entered by the user U01, as illustrated in the lower part of FIG. 11, the data management unit 350 changes the value of the status 334 of the record added to the apparatus registration table 330 from "unverified" to "verified".

FIG. 12 illustrates an example of an update of the delivered pack table 340 performed at the time of pack delivery. In the upper part of FIG. 12, an account table 320 including the same items as those in FIG. 11 is illustrated. In the middle part of FIG. 12, a delivered pack table 340 including, as data items, a contractant 341, a pack ID 342, a dispatch date 343, a status 344, and a usage date 345 is illustrated. In the example illustrated in FIG. 12, a replenishment pack identified by a pack ID "P01" has already been provided to the user U01, and the replenishment pack is used.

In response to detecting one of the above-described trigger events, the provision management unit 360 newly allocates a replenishment pack identified by a pack ID "P11" (hereinafter, will be referred to as a replenishment pack P11) to the user U01. Further, the provision management unit 360 adds a record for managing the status of the allocated replenishment pack P11 to the delivered pack table 340. In the added record, the contractant 341 shows "U01", the pack ID 342 shows "P11", the dispatch date 343 shows a date on which dispatch is to be performed, the status 344 shows "dispatched", and the usage date 345 is blank.

When the replenishment pack P11 arrives at the user and toner is replenished to the replenishment-target apparatus, the replenishment-target apparatus reports the increase in the remaining amount of toner to the management server 301. The data management unit 350 changes the value of the status 344 of the record added to the delivered pack table 340 based on the report from "dispatched" to "used", and adds to the usage date 345 a date on which the increase in remaining amount of toner has been reported.

### 2-3. Configuration Example of Image Forming Apparatus

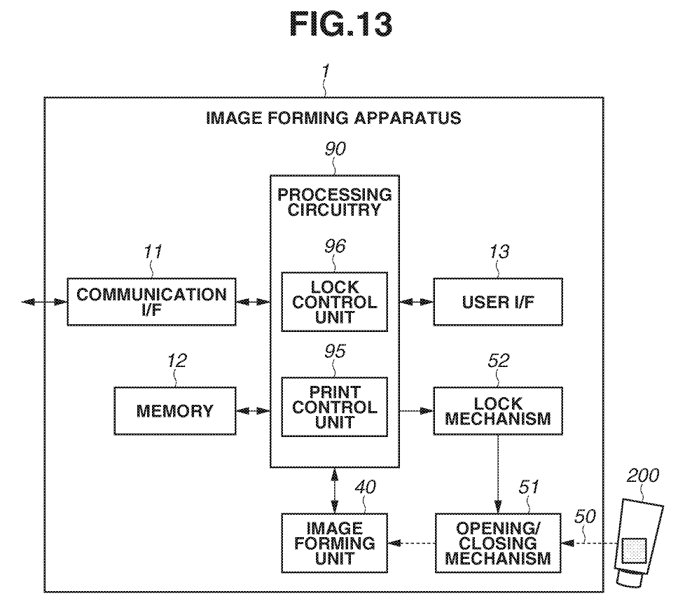

FIG. 13 is a block diagram illustrating an example of a functional configuration of the image forming apparatus 1 according to the present embodiment. As illustrated in FIG. 13, the image forming apparatus 1 includes a communication I/F 11, a memory 12, a user I/F 13, the image forming unit 40, an opening and closing mechanism 51, a lock mechanism 52, and the processing circuitry 90.

The communication I/F 11 is used for the image forming apparatus 1 to communicate with another apparatus through. The communication I/F 11 communicates with the user terminal 401 that exists in the user environment E1, and the management server 301 that exists in the remote environment E2. The communication I/F 11 may be a wired or wireless communication interface. In a case where the communication I/F 11 is a wireless communication interface, the communication I/F 11 may be a wireless local area network (WLAN) interface or a cellular communication interface, for example. FIG. 13 illustrates only a single communication I/F 11, but the image forming apparatus 1 may include a plurality of different communication modules for communicating with the user terminal 401 and the management server 301, respectively.

The memory 12 stores one or more computer programs to be executed by the processing circuitry 90, and various types of data. The memory 12 stores in advance, for example, an apparatus ID (will also be referred to as apparatus identification information) for uniquely identifying the image forming apparatus 1. The memory 12 may include a storage medium of a desired type, for example, a semiconductor memory, such as a ROM or a RAM, an optical disk, or a magnetic disk. Examples of the memory 12 may include a non-transitory computer-readable storage medium.

The user I/F 13 includes an input device for receiving the user’s operations and information input by the user, and a display device for displaying images and information. For example, the user I/F 13 can include one or more of the following items: a touch panel, a keypad, a button, a switch, a microphone, and a speaker. The user I/F 13 may be treated as an operation terminal integrated with the image forming apparatus 1.

As described with reference to FIG. 2, the image forming unit 40 forms an image on a recording medium, such as a sheet, while consuming toner stored in the storage unit 48. The opening and closing mechanism 51 can open and close a replenishing path 50 leading to the storage unit 48 from the replenishment pack 200 connected to the toner receiver portion 110. The above-described ring member 111 including the lever 111b and the protruding portion 111d, the pack shutter 214 of the replenishment pack 200, and the main body shutter 116 are included as examples in the opening and closing mechanism 51.

The lock mechanism 52 inhibits (i.e., locks) an operation of the opening and closing mechanism 51 performed by the user, or automatic actuation of the opening and closing mechanism 51, and cancels the inhibition (unlocks). The above-described lock unit 150 is included as an example in the lock mechanism 52.

From the functional viewpoint, the above-described group of electronic components 91, 92, and 93 of the processing circuitry 90 can mainly function as a print control unit 95 and a lock control unit 96. The print control unit 95 controls the operation for image formation performed by the image forming unit 40. For example, in response to a print job being received from an external device via the communication I/F 11, the print control unit 95 controls the image forming unit 40 to form an image on a recording medium based on input image data included in the print job.

In response to receiving an unlock command, the lock control unit 96 causes the lock mechanism 52 to unlock the opening and closing mechanism 51 based on the unlock command. For example, the lock control unit 96 may supply power to the solenoid of the lock unit 150 to pivot the lock member 152 as in the example illustrated in FIG. 8B. This allows the user to open the replenishing path 50 by rotating the main body shutter 116 and the pack shutter 214 of the replenishment pack 200 together with the ring member 111. In a case where a configuration is employed in which the image forming apparatus 1 automatically actuates the opening and closing mechanism 51, the lock control unit 96 may wait to receive an opening command instead of an unlock command, and open the replenishing path 50 by actuating the opening and closing mechanism 51 based on the received open command.

At the time of performing an image formation operation and at the time of replenishment of a consumable, the print control unit 95 controls the remaining amount detection unit 61 to detect the remaining amount of toner in the storage unit 48. While toner stored in the storage unit 48 is being agitated by the agitation member 60, the remaining amount detection unit 61 causes the light emitter 61a to emit light, and acquires a light detection signal from the light receiver 61b. The remaining amount detection unit 61 then estimates the remaining amount of toner based on the acquired light detection signal, and then reports the estimated remaining amount of toner to the print control unit 95. The print control unit 95 reports (notifies) remaining amount information indicating the remaining amount of toner detected in this manner to the management server 301 via the communication I/F 11.

As toner replenishment is performed, the remaining amount of toner increases. As described above, by detecting an increase in the remaining amount of toner based on the remaining amount information, the management server 301 determines that the dispatched replenishment pack 200 has been used by the user. In place of the management server 301, the image forming apparatus 1 may detect an increase in the remaining amount of toner, and then transmit to the management server 301 a notification signal indicating that the replenishment pack 200 has been used.

### 2-4. Procedure for Processing of Replenishment Management

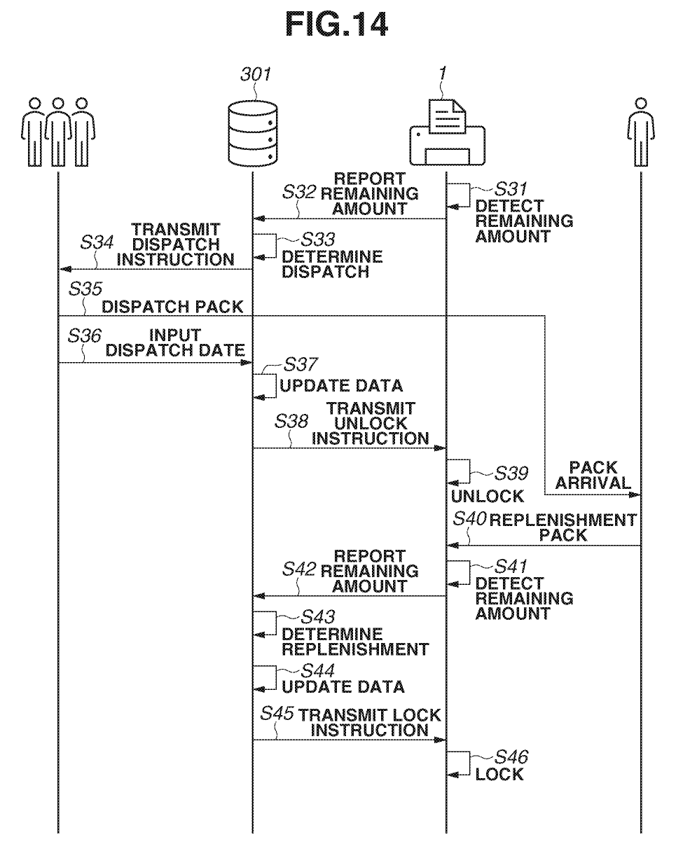

A procedure for processing executed at the time of replenishment management according to features of the present embodiment will now be described with reference to a sequence diagram in FIG. 14. A series of processes executed at the time of replenishment management, which will be described with reference to FIG. 14, assists the user in performing toner replenishment on the image forming apparatus 1 using a genuine replenishment pack provided to the user. The series of processes is then directed to providing a replenishment management system that can prevent the user from experiencing a phenomenon, such as a failure, malfunction, or degradation in image quality of the image forming apparatus 1, or depletion of toner at an unexpected timing.

The sequence illustrated in FIG. 14 is mainly executed by the image forming apparatus 1 and the management server 301, which are constituents of the system according to the present embodiment. Further, the provision management unit 360 of the management server 301 continuously monitors occurrence of trigger events that trigger provision of the replenishment pack 200 to the user. In this case, as an example of the trigger event, arrival of a provision timing based on a decrease in the remaining amount of toner will be described.

In step S31, the print control unit 95 of the image forming apparatus 1 detects the remaining amount of toner in the storage unit 48 during an image formation operation. Here, the remaining amount of toner is assumed to fall below a remaining amount threshold that triggers provision of a new replenishment pack 200.

In step S32, the print control unit 95 notifies (reports) the management server 301 of remaining amount information indicating the detected remaining amount of toner.

In step S33, the provision management unit 360 of the management server 301 detects that the remaining amount of toner in the image forming apparatus 1 has decreased, and determines that a new replenishment pack is to be dispatched to the user who owns the image forming apparatus 1.

In step S34, the provision management unit 360 transmits to a delivery person (the delivery person illustrated on the left in FIG. 14) a message that issues an instruction to deliver a new replenishment pack 200 to the user. The delivery instruction is issued by displaying the message on a not-illustrated display device of the management server 301. Alternatively, the delivery instruction is issued by the management server 301 transmitting a notification to a terminal owned by the delivery person.

In step S35, a new replenishment pack 200 is dispatched from the delivery person to the user who uses the image forming apparatus 1 (the user illustrated on the right in FIG. 14).

In step S36, a dispatch date of the replenishment pack is input to the management server 301 by the delivery person. In this case, when the dispatch procedure has already been completed, the dispatch date is input. However, if the dispatch procedure of a replenishment pack has not yet been completed, a scheduled dispatch date may be input.

In step S37, the data management unit 350 of the management server 301 updates the dispatch date 343 registered in the delivered pack table 340 with the dispatch date input in step S36, and also updates the status 344 in the delivered pack table 340 to "dispatched". Further, the dispatch date 343 is an example of delivery information about the replenishment pack 200. Other than the dispatch date 343, the delivery information includes a delivery person, a destination, identification information about the replenishment pack 200, and identification information about the image forming apparatus 1.

In step S38, in response to the status 344 being changed to "dispatched", the replenishment management unit 370 of the management server 301 transmits to the image forming apparatus 1 an unlock command to cause the lock mechanism 52 of the image forming apparatus 1 to unlock the opening and closing mechanism 51.

In step S39, in response to receiving the unlock command from the management server 301, the lock control unit 96 of the image forming apparatus 1 causes the lock mechanism 52 to unlock the opening and closing mechanism 51.

In step S40, by the user who uses the image forming apparatus 1 operating the unlocked opening and closing mechanism 51, the replenishing path 50 is opened to replenish a consumable from the replenishment pack 200 to the image forming apparatus 1. The opening of the replenishing path 50 may be automatically actuated and executed instead of being performed by the user’s operation.

In step S41, the print control unit 95 detects the remaining amount of toner in the storage unit 48. In step S42, the print control unit 95 notifies (reports) the management server 301 of remaining amount information indicating the detected remaining amount of toner. In step S43, if the remaining amount of toner received in step S42 has increased from the remaining amount of toner 335 recorded in the apparatus registration table 330, the data management unit 350 of the management server 301 determines that replenishment has been performed using the dispatched replenishment pack 200.

In step S44, if it is determined that replenishment has been executed using the replenishment pack dispatched in step S35, the data management unit 350 updates the remaining amount of toner 335 in the apparatus registration table 330 with the remaining amount of toner received in step S42, and also updates the status 344 in the delivered pack table 340 to "replenished".

In step S45, the replenishment management unit 370 transmits to the image forming apparatus 1 a lock command to cause the lock mechanism 52 of the image forming apparatus 1 to lock the opening and closing mechanism 51.

In step S46, in response to receiving the lock command from the management server 301, the lock control unit 96 of the image forming apparatus 1 causes the lock mechanism 52 to lock the opening and closing mechanism 51 again.

As described above with reference to steps S36 to S39, the lock mechanism 52 of the image forming apparatus 1 is unlocked using delivery information about the replenishment pack 200 as a trigger. The lock mechanism 52 can be unlocked at a timing at which a dispatched replenishment pack arrives at the user, and thus a situation can be avoided in which the user performs replenishment using an inappropriate replenishment pack before the arrival of the dispatched replenishment pack 200. Further, by unlocking the lock mechanism 52 of the image forming apparatus 1 based on the delivery information about the replenishment pack 200, an authentication operation performed by the user is unnecessary. Thus, the workload imposed on the user for authentication, and the cost associated with a configuration required for authentication can be reduced.

### Second Embodiment

In a second embodiment, a configuration is employed in which an expected arrival date is provided in the delivered pack table 340 of the management server 301 instead of a scheduled dispatch date. A series of processes including provision of a replenishment pack and replenishment of a consumable according to the second embodiment will be described.

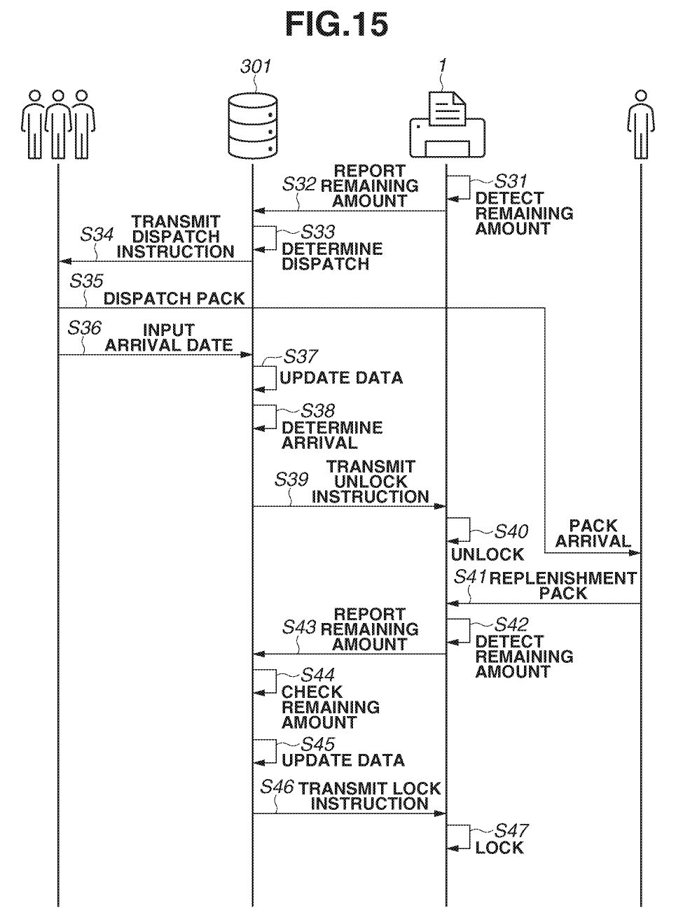

FIG. 15 is a sequence diagram illustrating an example of a procedure for schematic processing according to the second embodiment executed at the time of provision of a replenishment pack and replenishment of a consumable. The image forming apparatus 1 and the management server 301 are mainly involved in the sequence illustrated in FIG. 15.

The initial processing steps from detection of the remaining amount to dispatch of the replenishment pack 200 in steps S31 to S35 may be the same as those in the first embodiment as illustrated in FIG. 14, and thus the redundant description will be omitted.

In step S36, an expected arrival date of the replenishment pack 200 at the user is input by the delivery person.

In the present embodiment, an example of inputting an expected arrival date has been described, but the delivery person may confirm arrival at the user and input the arrival date instead of the expected arrival date.

In step S37, the data management unit 350 updates the expected arrival date in the delivered pack table 340.

In step S38, the provision management unit 360 determines the arrival of the replenishment pack 200 at the user based on the input expected arrival date. If the provision management unit 360 determines that the replenishment pack 200 arrives at the user, the processing proceeds to step S39. In step S39, the provision management unit 360 transmits to the image forming apparatus 1 an unlock command to cause the lock mechanism 52 of the image forming apparatus 1 to unlock the opening and closing mechanism 51.

The subsequent processing steps from unlocking of the lock mechanism 52 to re-locking of the lock mechanism 52 in steps S40 to S47 may be the same as those in the first embodiment as illustrated in FIG. 14, and thus the redundant description will be omitted.

As described above, the lock mechanism 52 of the image forming apparatus 1 is unlocked using an expected arrival date of the replenishment pack 200 as a trigger. With this configuration, the lock mechanism 52 of the image forming apparatus 1 can be unlocked accurately at the timing at which the replenishment pack 200 arrives at the user compared with the first embodiment in which the lock mechanism 52 of the image forming apparatus 1 is unlocked immediately after the dispatched status is input to the management server 301. Thus, it is possible to increase the likelihood of avoiding a situation in which the user performs replenishment using an inappropriate replenishment pack before the arrival of the dispatched replenishment pack 200.

### Third Embodiment

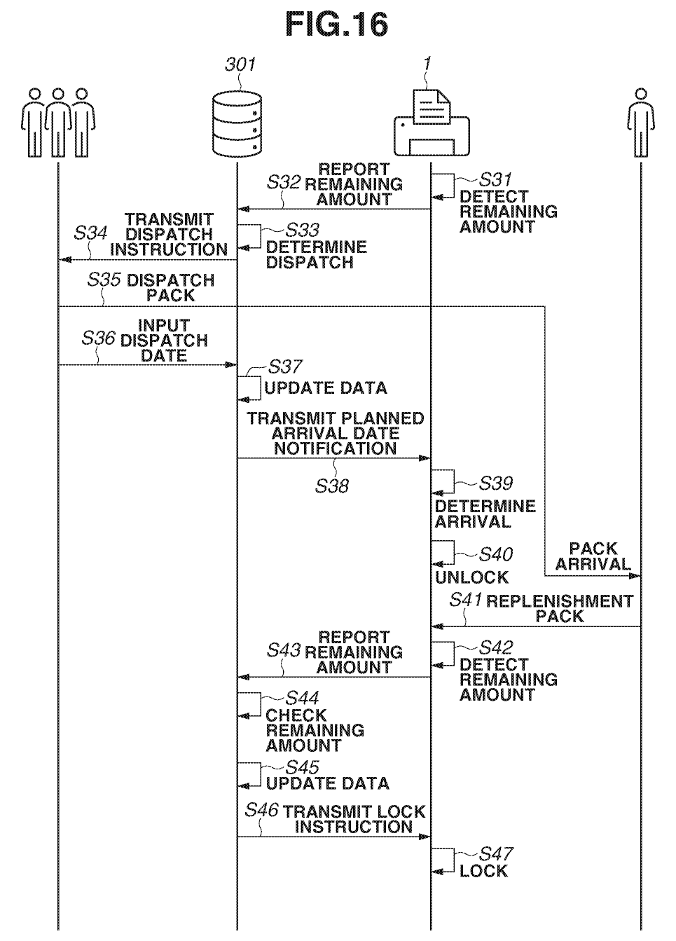

In the third embodiment, instead of providing a replenishment management unit in the management server 301, a replenishment management unit is provided in the image forming apparatus 1. A series of processes including provision of a replenishment pack and replenishment of a consumable according to the third embodiment will be described. FIG. 16 is a sequence diagram illustrating an example of a procedure for schematic processing according to the third embodiment executed at the time of the provision of a replenishment pack and the replenishment of a consumable. The image forming apparatus 1 and the management server 301 are mainly involved in the sequence illustrated in FIG. 16.

The initial processing steps from detecting the remaining amount to updating the data in steps S31 to S37 may be the same as those in the second embodiment as illustrated in FIG. 15, and thus the redundant description will be omitted.

In step S38, if the management server 301 notifies the image forming apparatus 1 of an expected arrival date of the replenishment pack 200, the processing proceeds to step S39. In step S39, the replenishment management unit of the image forming apparatus 1 determines the arrival of the replenishment pack at the user based on the input expected arrival date.

If it is determined in step S39 that the replenishment pack 200 arrives at the user soon, the processing proceeds to step S40. In step S40, the lock control unit 96 of the image forming apparatus 1 causes the lock mechanism 52 to unlock the opening and closing mechanism 51.

The subsequent processing steps from unlocking of the lock mechanism 52 to re-locking of the lock mechanism 52 in steps S41 to S47 may be the same as those in the second embodiment as illustrated in FIG. 15, and thus the redundant description will be omitted.

As described above, according to the third embodiment, the management server 301 notifies the image forming apparatus 1 of delivery information about the replenishment pack 200, and the image forming apparatus 1 unlocks the lock mechanism 52 based on the delivery information about the replenishment pack 200. In other words, the lock mechanism 52 can be unlocked at the timing at which the dispatched replenishment pack 200 arrives at the user. Thus, a situation can be avoided in which the user performs replenishment using an inappropriate replenishment pack before the arrival of the dispatched replenishment pack 200.

Further, the configuration in which the image forming apparatus 1 determines whether to unlock the lock mechanism 52 based on delivery information about the replenishment pack 200 notified from the management server 301 as in the third embodiment has the following advantages. Compared with the configuration in which the lock mechanism 52 is unlocked based on an unlock instruction notified from the management server 301 as in the second embodiment, there is buffer time between the time at which a notification from the management server 301 is received by the image forming apparatus 1 and the time at which the replenishment pack 200 arrives at the user. Thus, due to unstable communication via the external network N2 between the management server 301 and the image forming apparatus 1, or due to a power-off of the image forming apparatus, the image forming apparatus 1 may not be able to receive a notification from the management server 301 at the initial attempt. Even in such a case, the management server 301 can issue a notification again to the image forming apparatus 1, allowing the image forming apparatus 1 to receive the notification from the management server 301.

The technique according to the present disclosure can also be applied to a printer of another type, such as a full-color laser printer or an inkjet printer. In general, the technique according to the present disclosure can be broadly applied to image forming apparatuses, such as a copying machine, a printer, a facsimile receiver, and a multifunction peripheral. Further, a configuration in which an accommodating device is attached to the image forming apparatus 1 has been described using the replenishment pack 200 as an example, but the present disclosure can also be applied to a configuration in which a cartridge-type consumable is attached to an image forming apparatus.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-037822, filed Mar. 10, 2025, which is hereby incorporated by reference herein in its entirety.

What is claimed is:

1. A system including an image forming apparatus to which an accommodating device that contains a consumable to be used for image formation is detachably attached, and a server apparatus that communicates with the image forming apparatus via a network,
the image forming apparatus comprising:
a replenishing path configured to replenish the consumable from the attached accommodating device;
an opening and closing mechanism configured to open and close the replenishing path;
a lock mechanism configured to lock actuation of the opening and closing mechanism;
a consumable container configured to contain the consumable replenished from the accommodating device;
at least one memory that stores a set of instructions;
at least one processor that executes the instructions causing the image forming apparatus to perform operations comprising:
a detection unit configured to detect an amount of the consumable contained in the consumable container; and
a notification unit configured to notify the server apparatus of information regarding the amount of the consumable detected by the detection unit;
the server apparatus comprising:
at least one memory that stores a set of instructions;
at least one processor that executes the instructions causing the server apparatus to perform operations comprising:
a delivery instruction unit configured to issue an instruction to deliver the accommodating device to be used by the image forming apparatus in accordance with the information regarding the amount of the consumable notified from the image forming apparatus; and
a transmission unit configured to transmit to the image forming apparatus, in a case where the accommodating device is delivered to the image forming apparatus based on the delivery instruction issued by the delivery instruction unit, an instruction to unlock the lock mechanism.

2. The system according to claim 1, wherein, in a case where delivery information regarding delivery of the accommodating device is input to the server apparatus, the server apparatus transmits the instruction to unlock the lock mechanism to the image forming apparatus.

3. The system according to claim 2, wherein the delivery information about the accommodating device is a dispatch date, a scheduled dispatch date, an arrival date, or an expected arrival date of the accommodating device.

4. The system according to claim 1, wherein, in a case where an increase in the amount of the consumable contained in the consumable container is detected by the detection unit after the lock mechanism is unlocked, the opening and closing mechanism is locked by the lock mechanism.

5. A system including an image forming apparatus to which an accommodating device that contains a consumable to be used for image formation is detachably attached, and a server apparatus that communicates with the image forming apparatus via a network,
the image forming apparatus comprising:
an openable and closeable replenishing path configured to replenish the consumable from the attached accommodating device;
a consumable container configured to contain the consumable replenished from the accommodating device;
at least one memory that stores a set of instructions;
at least one processor that executes the instructions causing the server apparatus to perform operations comprising:
a detection unit configured to detect an amount of the consumable contained in the consumable container;
a notification unit configured to notify the server apparatus of information regarding the amount of the consumable detected by the detection unit; and
a control unit configured to control opening and closing of the replenishing path; and
the server apparatus comprising:
at least one memory that stores a set of instructions;
at least one processor that executes the instructions causing the server apparatus to perform operations comprising:
a delivery instruction unit configured to issue an instruction to deliver the accommodating device to be used by the image forming apparatus in accordance with the information regarding the amount of the consumable notified from the image forming apparatus; and
a transmission unit configured to transmit to the image forming apparatus, in a case where the accommodating device is delivered to the image forming apparatus based on the delivery instruction issued by the delivery instruction unit, delivery information regarding delivery of the accommodating device,
wherein the control unit performs opening of the replenishing path based on the delivery information transmitted from the server apparatus.

6. The system according to claim 5, wherein the delivery information about the accommodating device is a dispatch date, a scheduled dispatch date, an arrival date, or an expected arrival date of the accommodating device.

7. The system according to claim 5, wherein, in a case where the delivery information regarding delivery of the accommodating device is input to the server apparatus, the server apparatus transmits the input delivery information to the image forming apparatus.

8. The system according to claim 5, wherein, in a case where an increase in the amount of the consumable contained in the consumable container is detected by the detection unit after the replenishing path is opened, the replenishing path is locked by the control unit.
